(19) United States
(12) Patent Application Publication
(10) Pub. No.: US 2011/0001331 A1
(43) Pub. Date: Jan. 6, 2011

(54) WINDSHIELD ASSEMBLY FOR GOLF CARTS AND OTHER VEHICLES

(76) Inventor: Paul J. Hirneise, Gainesville, FL (US)

Correspondence Address: EDWARD M. LIVINGSTON, PA, 963 TRAIL TERRACE DRIVE, NAPLES, FL, 34103, US

(21) Appl. No.: 12/495,955

(22) Filed: Jul. 1, 2009

(51) Int. Cl. B60J 1/00

(52) U.S. Cl. 296/87; 296/84.1

(57) ABSTRACT

A folding windshield assembly (1) for a vehicle, such as a golf cart (11), that folds against a roof (15) of the vehicle when not in use. The windshield assembly comprises a bottom panel (2) and a top panel (3). A top edge (4) of the bottom panel is attached to a bottom edge (5) of the top panel by a hinge (6). Bottom corners (7) on side edges (17) of the bottom panel are slideably and pivotally attached to tracks (8) and front posts (9) of a upper structure (10) of a vehicle. Top corners (12) on side edges (18) of the top panel are pivotally attached to the front vertical posts of the upper structure. Gas springs (13) are mounted to the top panel and the front posts to assist with folding the windshield assembly up and down.

### BACKGROUND OF THE INVENTION

This invention relates to windshields, more particularly, a folding windshield assembly for golf carts and other vehicles that allows a user to quickly and easily open and store the windshield so that the windshield assembly is out of the way and the front of the vehicle is completely open for air flow and visibility.

Many vehicles, such as golf carts, typically have windshields that protect occupants from wind and rain. Most golf cart windshields comprise a single panel that is fixedly attached to the front of a upper structure on a golf cart. Other golf cart windshields comprise a top panel and a bottom panel. The bottom panel is fixedly attached to the front of the upper structure and the top panel is attached to the bottom panel by a horizontal hinge. A user may fold the top panel down during nice weather or fold the top panel up for protection against wind and rain. When the top panel is folded up, it is secured to the upper structure using clips. A problem with these assemblies is that the front of the golf cart is either entirely covered or partially covered at all times, thereby blocking air flow and the view of the occupants. An additional problem is that current windshield assemblies having two panels often require stopping and exiting the vehicle to open and close the windshield.

Therefore, a need exists for a windshield that is easy to operate and folds completely out of the way leaving the front of a golf cart completely open.

The relevant prior art includes the following references:

| Pat. No. | | |
|---|---|---|
| (U.S. unless | | |
| stated otherwise) | Inventor | Issue/Publication Date |
| 7,044,534 | Ishibashi et al. | May. 16, 2006 |
| 5,362,118 | Houriez | Nov. 08, 1998 |
| 5,826,440 | Okada et al. | Oct. 27, 1998 |
| JP406040250 | Fujii et al. | Feb. 15, 1994 |
| 5,272,836 | Gerst et al. | Dec. 28, 1993 |
| 5,195,797 | Hobbs | Mar. 23, 1993 |
| 5,192,109 | Roberts | Mar. 09, 1993 |
| 4,518,195 | Tindall et al. | May 21, 1985 |
| 4,072,338 | Lawrence et al. | Feb. 07, 1978 |
| 798,447 | Pfleghar | Aug. 29, 1905 |

### SUMMARY OF THE INVENTION

The primary object of the present invention is to provide a windshield assembly that allows a user to quickly and easily open the windshield.

A further object of the present invention is to provide windshield assembly does not cover any portion of the front of a golf cart while in an open and stored position.

Another object of the present invention is to provide windshield assembly that completely stores out of the way when not in use.

An even further object of the present invention is to provide a windshield assembly that can easily be installed on any vehicle.

An additional object of the present invention is to provide a windshield assembly that improves air flow and visibility.

The present invention fulfills the above and other objects by providing a folding windshield assembly that folds up toward the roof of a vehicle when not in use. The windshield comprises a bottom panel and a top panel. A top edge of the bottom panel is attached to a bottom edge of the top panel by a horizontal hinge. Bottom corners of the bottom panel are slideably and pivotally attached to tracks mounted to components of a vehicle. Top corners of the top panel are pivotally attached to the front posts of a upper structure of the vehicles. Gas springs are mounted to the top panel and the front posts to assist with folding the windshield assembly up and down. A handle, which is used to open and close the windshield assembly, may be mounted on the top panel or bottom panel near the horizontal hinge. To store the windshield when not in use, a user simply pulls the handle inward causing the bottom edge of the top panel to pivot inward and upward towards the roof while the bottom panel slides upward guided by the tracks and the upper edge of the bottom panel pivots inward, thereby folding the bottom panel under the top panel. The folded windshield assembly rests against the underside of the roof of the vehicle when in the open and stored position and is held in place by the gas springs. To fold the windshield down into a closed position for protection from wind and/or rain, a user simply pulls the handle downward and the bottom edge of the top panel pivots downward and outward while the bottom panel slides downward guided by the tracks and the top edge of the bottom panel pivots outward into the closed position. The windshield assembly may be locked into the closed position using clips located on either side of the windshield assembly.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a vehicle windshield assembly of the present invention in a closed position on a golf cart;

FIG. 2 is a rear view of a vehicle windshield assembly of the present invention in a closed position on a golf cart; and

FIG. 3 is a side view of a vehicle windshield assembly of the present invention in an open and stored position on a golf cart.

### DESCRIPTION OF THE PREFERRED EMBODIMENTS

For purposes of describing the preferred embodiment, the terminology used in reference to the numbered accessories in the drawings is as follows:
1. windshield assembly
2. bottom panel
3. top panel
4. top edge of bottom panel
5. bottom edge of top panel
6. hinge
7. bottom corner
8. track
9. post
10. upper structure
11. golf cart
12. top corner
13. gas spring
14. handle
15. roof
16. locking means
17. side edge of bottom panel
18. side edge of top panel
19. rear surface of panel
20. front surface of panel
21. top edge of top panel
22. bottom edge of bottom panel

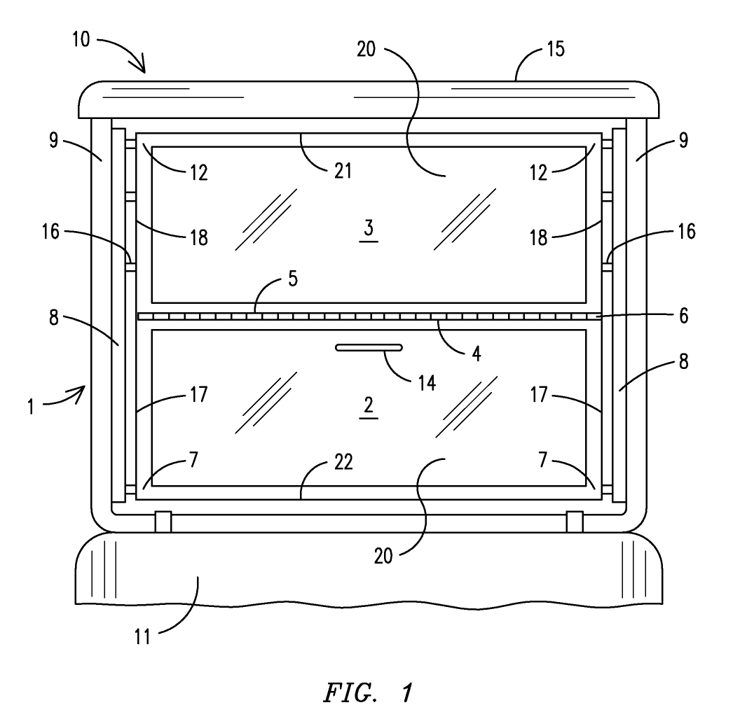

With reference to FIG. 1, a front view of a vehicle windshield assembly 1 of the present invention in a closed position on a golf cart 11 is shown. The windshield assembly 1 comprises a bottom panel 2 and a top panel 3 each having a top edge 4, 21, a bottom edge 5, 22, side edges 17, 18, front surfaces 20 and rear surfaces 19. A top edge 4 of the bottom panel 2 is attached to a bottom edge 5 of the top panel 3 by a horizontal hinge 6. Bottom corners 7 on side edges 17 of the bottom panel 2 are slideably and pivotally attached to tracks 8 mounted to vertical posts 9 of an upper structure 10 of a golf cart 11. Top corners 12 on side edges 18 of the top panel 3 are pivotally attached to the front posts 9 of an upper structure 10 of the golf cart 11. A handle 14, which is used to open and close the windshield assembly 1, may be mounted on the top panel 3 or bottom panel 2 on the rear surface 19 near the horizontal hinge 6. The windshield assembly 1 may be locked into the closed position using clips 16 located on either side of the windshield assembly 1.

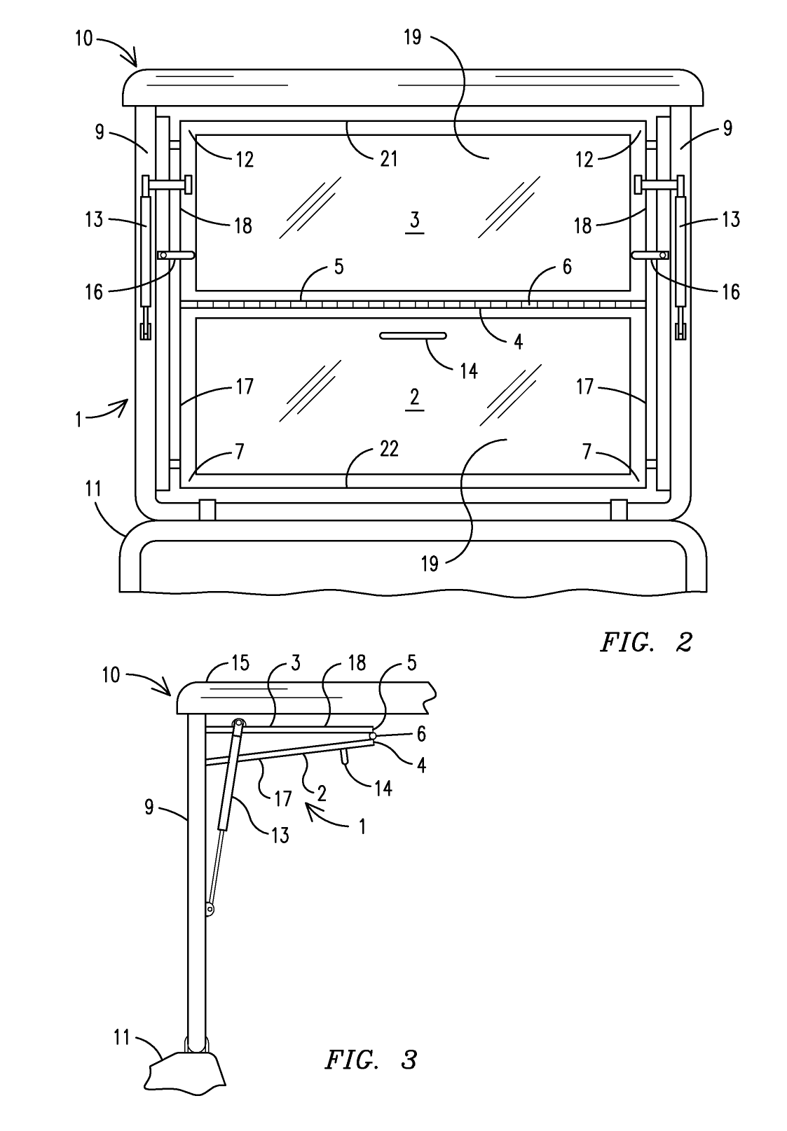

Now referring to FIG. 2, a rear view of a windshield assembly 1 of the present invention in a closed position on a golf cart 11 is shown. The windshield assembly 1 comprises a bottom panel 2 and a top panel 3 each having a top edge 4, 21, a bottom edge 5, 22, side edges 17, 18, front surfaces 20 and rear surfaces 19. A top edge 4 of the bottom panel 2 is attached to a bottom edge 5 of the top panel 3 by a horizontal hinge 6. Bottom corners 7 on side edges 17 of the bottom panel 2 are slideably and pivotally attached to tracks 8 mounted to vertical posts 9 of an upper structure 10 of a golf cart 11. Top corners 12 on side edges 18 of the top panel 3 are pivotally attached to the front posts 9 of an upper structure 10 of the golf cart 11. Gas springs 13 are attached to the top panel 3 and the front posts 9 to assist with folding the windshield assembly 1 up and down, as further shown in FIG. 3. A handle 14, which is used to open and close the windshield assembly 1, may be mounted on the top panel 3 or bottom panel 2 on the rear surface 19 near the horizontal hinge 6. The windshield assembly 1 may be locked into the closed position using clips 16 located on either side of the windshield assembly 1.

Finally referring to FIG. 3, a side view of a windshield assembly 1 of the present invention in an open and stored position on a golf cart 11 is shown. The windshield assembly 1 comprises a bottom panel 2 and a top panel 3 each having a top edge 4, 21, a bottom edge 5, 22, side edges 17, 18, front surfaces 20 and rear surfaces 19. A top edge 4 of the bottom panel 2 is attached to a bottom edge 5 of the top panel 3 by a horizontal hinge 6. Bottom corners 7 on side edges 17 of the bottom panel 2 are slideably and pivotally attached to tracks 8 mounted to vertical posts 9 of an upper structure 10 of a golf cart 11. as shown in FIGS. 1 and 2. Top corners 12 of the top panel 3 are pivotally attached to the front posts 9 of an upper structure 10 of the golf cart 12, as shown in FIGS. 1 and 2. Gas springs 13 are attached to the top panel 3 and the front posts 9 to assist with folding the windshield assembly 1 up and down, as further shown in FIG. 3. A handle 14, which is used to open and close the windshield assembly 1, may be mounted on the top panel 3 or bottom panel 2 on the rear surface 19 near the horizontal hinge 6. To open and store the windshield assembly 1 when not in use, a user simply pulls the handle 14 inward causing the bottom edge 5 of the top panel 3 to pivot inward and upward towards the roof 15 while the bottom panel 2 slides upward guided by the tracks 8 and the top edge 4 of the bottom panel 2 pivots inward, thereby folding the bottom panel 2 under the top panel 3. The folded windshield assembly 1 rests under the roof 15 of the golf cart 11 when in the open and stored position and is held in place by the gas springs 13. To fold the windshield assembly 11 down into a closed position for protection from wind and/or rain, as shown in FIGS. 1 and 2, a user simply pulls the handle 14 downward and the bottom edge 5 of the top panel 3 pivots downward and outward while the bottom panel 2 slides downward guided by the tracks 8 and the top edge 4 of the bottom panel 2 pivots outward into the closed position.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A windshield assembly comprising:
a bottom panel having a top edge, a bottom edge, a front surface, a back surface and two sides attached to at least two vertical posts of an upper structure of a vehicle;
said bottom panel is pivotally and slidably attached to the at least two vertical posts;
a top panel having a top edge, a bottom edge, a front surface, a back surface and two sides attached to the at least two vertical posts and hingedly attached to the bottom panel; and
said top panel is pivotally attached to the at least two vertical posts.

2. The windshield assembly of claim 1 further comprising:
tracks attached to the at least two vertical posts that guide the slideably attached bottom panel.

3. The windshield assembly of claim 1 further comprising:
at least one gas spring attached to the at least two vertical posts and the windshield assembly.

4. The windshield assembly of claim 2 further comprising:
at least one gas spring attached to the at least two vertical posts and the windshield assembly.

5. The windshield assembly of claim 1 further comprising:
at least one handle attached to a back surface of a panel.

6. The windshield assembly of claim 2 further comprising:
at least one handle attached to a back surface of a panel.

7. The windshield assembly of claim 3 further comprising:
at least one handle attached to a back surface of a panel.

8. The windshield assembly of claim 1 further comprising:
at least one locking means to maintain the windshield assembly in a closed position.

9. The windshield assembly of claim 2 further comprising:
at least one locking means to maintain the windshield assembly in a closed position.

10. The windshield assembly of claim 3 further comprising:
at least one locking means to maintain the windshield assembly in a closed position.

11. A windshield assembly comprising:
a bottom panel having a top edge, a bottom edge, a front surface, a back surface and two sides attached to at least two vertical posts of an upper structure of a vehicle;
said bottom panel is pivotally and slidably attached to the at least two vertical posts;
a top panel having a top edge, a bottom edge, a front surface, a back surface and two sides attached to the at least two vertical posts and hingedly attached to the bottom panel;
said top panel is pivotally attached to the at least two vertical posts; and
tracks attached to the at least two vertical posts that guide the slideably attached bottom panel.

12. The windshield assembly of claim 11 further comprising:
at least one gas spring attached to the at least two vertical posts and the windshield assembly.

13. The windshield assembly of claim 11 further comprising:
at least one handle attached to a back surface of a panel.

14. The windshield assembly of claim 12 further comprising:
at least one handle attached to a back surface of a panel.

15. The windshield assembly of claim 11 further comprising:
at least one locking means to maintain the windshield assembly in a closed position.

16. The windshield assembly of claim 12 further comprising:
at least one locking means to maintain the windshield assembly in a closed position.

17. A golf cart windshield assembly comprising:
a bottom panel having a top edge, a bottom edge, a front surface, a back surface and two sides attached to at least two vertical posts of an upper structure of a vehicle;
said bottom panel is pivotally and slidably attached to the at least two vertical posts;
a top panel having a top edge, a bottom edge, a front surface, a back surface and two sides attached to the at least two vertical posts and hingedly attached to the bottom panel; and
said top panel is pivotally attached to the at least two vertical posts;
tracks attached to the at least two vertical posts that guide the slideably attached bottom panel; and
at least one gas spring attached to the at least two vertical posts and the windshield assembly.

18. The golf cart windshield assembly of claim 17 further comprising:
at least one handle attached to a back surface of a panel.

19. The golf cart windshield assembly of claim 17 further comprising:
at least one locking means to maintain the windshield assembly in a closed position.

20. The golf cart windshield assembly of claim 8, 9, 10, 15, 16 and 19 wherein:
said locking means is a clip.
